(19) United States
(12) Patent Application Publication
(10) Pub. No.: US 2026/0261412 A1
(43) Pub. Date: Sep. 3, 2026

(54) RESOURCE PROCESSING METHOD, SIGNATURE PRIVATE KEY OBTAINING METHOD, AND APPARATUS

(71) Applicant: Tencent Technology (Shenzhen) Company Limited, Shenzhen (CN)

(72) Inventor: Yi WU, Shenzhen (CN)

(73) Assignee: Tencent Technology (Shenzhen) Company Limited, Shenzhen, GD (CN)

(21) Appl. No.: 19/656,442

(22) Filed: Apr. 23, 2026

Related U.S. Application Data
(63) Continuation of application No. PCT/CN2024/136130, filed on Dec. 2, 2024.

(30) Foreign Application Priority Data
Jan. 2, 2024 (CN) 202410006773.4

(51) Int. Cl. H04L 9/08; H04L 9/30; H04L 9/32

(52) U.S. Cl. CPC H04L 9/0866; H04L 9/3066; H04L 9/3247

(57) ABSTRACT

A resource processing method is provided. The method includes: receiving a digital account creation request, extracting a digital account creator identifier therefrom; creating, based on the digital account creator identifier, a digital account for storing a virtual resource; obtaining a preset master public key and generating a signature public key of the digital account based on the master public key and the digital account creator identifier; obtaining a master private key paired with the master public key and generating, based on the master private key and the signature public key, a signature private key paired with the signature public key; transmitting the signature private key to a terminal and trigger the terminal to generate a digital signature; receiving a resource processing request from the terminal comprising the digital signature; and processing the virtual resource after verification of the digital signature based on the signature public key succeeds.

### RELATED APPLICATION

This application is a continuation application of PCT Patent Application No. PCT/CN2024/136130, filed on Dec. 2, 2024, which claims priority to Chinese Patent Application No. 202410006773.4, filed on Jan. 2, 2024, each of which is incorporated by reference in its entirety.

### FIELD OF THE TECHNOLOGY

This application relates to the field of computer technologies, and in particular, to a resource processing method, a signature private key obtaining method, and an apparatus.

### BACKGROUND OF THE DISCLOSURE

With development of science and technologies, a digital account appears. The digital account refers to a container configured for storing a virtual resource. For the digital account, each unit of virtual resource stored therein has a distinct resource identifier. The resource identifier refers to information that uniquely identifies the unit of virtual resource. A quantity of resources corresponding to each unit of virtual resource may vary. For example, a virtual resource of 100 resources may be considered as one unit of resource, or a virtual resource of one resource may be considered as one unit of resource.

Currently, in a process of creating the digital account, an additional master public-private key pair is generated, and the master public-private key pair and a digital account creator identifier are correspondingly stored in a database. However, if the master public-private key pair and the digital account creator identifier are correspondingly stored in the database, there is a risk that the master public-private key is attacked and stolen, reducing security of the digital account.

### SUMMARY OF THE DISCLOSURE

This application provides a resource processing method, a signature private key obtaining method, an apparatus, a computer device, a computer-readable storage medium, and a computer program product.

According to a first aspect, this application provides a resource processing method, performed by a computer device, and including:

extracting a digital account creator identifier from a digital account creation request in response to the digital account creation request when the digital account creation request is received;

creating, based on the digital account creator identifier, a digital account configured for storing a virtual resource;

obtaining a preset master public key, and generating a signature public key of the digital account based on the master public key and the digital account creator identifier;

obtaining a master private key paired with the master public key, and generating, based on the master private key and the signature public key, a signature private key paired with the signature public key;

transmitting the signature private key to a terminal corresponding to the digital account creator identifier, the transmitted signature private key being configured for triggering the terminal to generate a digital signature based on the signature private key;

receiving a resource processing request that is fed back by the terminal and that includes the digital signature; and

processing the virtual resource in the digital account based on the resource processing request after verification performed on the digital signature based on the signature public key of the digital account succeeds.

According to a second aspect, this application further provides a resource processing apparatus, including:

a signature public key generation module, configured to: extract a digital account creator identifier from a digital account creation request in response to the digital account creation request when the digital account creation request is received; create, based on the digital account creator identifier, a digital account configured for storing a virtual resource; and obtain a preset master public key, and generate a signature public key of the digital account based on the master public key and the digital account creator identifier;

a signature private key generation module, configured to: obtain a master private key paired with the master public key, and generate, based on the master private key and the signature public key, a signature private key paired with the signature public key;

a signature private key transmitting module, configured to transmit the signature private key to a terminal corresponding to the digital account creator identifier, the transmitted signature private key being configured for triggering the terminal to generate a digital signature based on the signature private key;

a resource processing request receiving module, configured to receive a resource processing request that is fed back by the terminal and that includes the digital signature; and

a resource processing module, configured to process the virtual resource in the digital account based on the resource processing request after verification performed on the digital signature based on the signature public key of the digital account succeeds.

According to a third aspect, this application further provides a computer device, the computer device including a memory and a processor, the memory having a computer program stored therein, and the processor executing the computer program to implement operations in any resource processing method provided in embodiments of this disclosure.

According to a fourth aspect, this application further provides a computer-readable storage medium, the computer-readable storage medium having a computer program stored therein, and the computer program being executed by a processor to implement operations in any resource processing method provided in embodiments of this disclosure.

According to a fifth aspect, this application further provides a computer program product, the computer program product including a computer program, and the computer program being executed by a processor to implement operations in any resource processing method provided in embodiments of this disclosure.

According to a sixth aspect, this application provides a signature private key obtaining method, including:

obtaining a digital account creator identifier, and generating a digital account creation request based on the digital account creator identifier;

transmitting the digital account creation request, the transmitted digital account creation request being configured for triggering creation of a digital account, a signature public key, and a signature private key based on the digital account creator identifier, and being configured for triggering generation of a verification code and encryption of the signature private key based on the verification code, to obtain an encrypted private key;

receiving the encrypted private key and the verification code; and

decrypting the encrypted private key based on the verification code, to obtain the signature private key, the signature private key being configured for generating, in a resource processing process based on the signature private key, a resource processing request including a digital signature, and the digital signature being configured for triggering processing of a virtual resource in the digital account based on the resource processing request after verification performed on the digital signature based on the signature public key bound with the digital account succeeds.

According to a seventh aspect, this application provides a signature private key obtaining apparatus, including:

a request generation module, configured to: obtain a digital account creator identifier, and generate a digital account creation request based on the digital account creator identifier;

a request transmitting module, configured to transmit the digital account creation request, the transmitted digital account creation request being configured for triggering creation of a digital account, a signature public key, and a signature private key based on the digital account creator identifier, and being configured for triggering generation of a verification code and encryption of the signature private key based on the verification code, to obtain an encrypted private key; and

a key receiving module, configured to: receive the encrypted private key and the verification code, and decrypt the encrypted private key based on the verification code, to obtain the signature private key, the signature private key being configured for generating, in a resource processing process based on the signature private key, a resource processing request including a digital signature, and the digital signature being configured for triggering processing of a virtual resource in the digital account based on the resource processing request after verification performed on the digital signature based on the signature public key bound with the digital account succeeds.

According to an eighth aspect, this application further provides a computer device, the computer device including a memory and a processor, the memory having a computer program stored therein, and the processor executing the computer program to implement operations in any signature private key obtaining method provided in embodiments of this disclosure.

According to a ninth aspect, this application further provides a computer-readable storage medium, the computer-readable storage medium having a computer program stored therein, and the computer program being executed by a processor to implement operations in any signature private key obtaining method provided in embodiments of this disclosure.

According to a tenth aspect, this application further provides a computer program product, the computer program product including a computer program, and the computer program being executed by a processor to implement operations in any signature private key obtaining method provided in embodiments of this disclosure.

Details of one or more embodiments of this disclosure are provided in the accompanying drawings and descriptions below. Other features, objectives, and advantages of this application become apparent from the specification, the accompanying drawings, and the claims.

### BRIEF DESCRIPTION OF THE DRAWINGS

To describe technical solutions in embodiments of this disclosure or the conventional technology more clearly, the following briefly describes the accompanying drawings required for describing the embodiments or the conventional technology. Apparently, the accompanying drawings in the following descriptions show merely embodiments of this disclosure, and a person of ordinary skill in the art may still derive other accompanying drawings from the disclosed accompanying drawings without creative efforts.

FIG. 1 is a diagram of an application environment of a resource processing method according to an embodiment.

FIG. 2 is a schematic diagram of a blockchain network according to an embodiment.

FIG. 3 is a schematic flowchart of a resource processing method according to an embodiment.

FIG. 4 is a schematic diagram of an account creation page according to an embodiment.

FIG. 5 is a schematic diagram of generating a signature public key according to an embodiment.

FIG. 6 is a schematic diagram of generating a signature public key according to another embodiment.

FIG. 7 is a schematic diagram of displaying a signature public key according to an embodiment.

FIG. 8 is a schematic diagram of generating a first encryption key according to an embodiment.

FIG. 9 is a schematic flowchart of a signature private key obtaining method according to an embodiment.

FIG. 10 is a schematic diagram of entering a verification code according to an embodiment.

FIG. 11 is a schematic diagram of a detail page according to an embodiment.

FIG. 12 is a schematic flowchart of a virtual resource processing method according to an embodiment.

FIG. 13 is a structural block diagram of a resource processing apparatus according to an embodiment.

FIG. 14 is a structural block diagram of a signature private key obtaining apparatus according to an embodiment.

FIG. 15 is a diagram of an internal structure of a computer device according to an embodiment.

FIG. 16 is a diagram of an internal structure of a computer device according to an embodiment.

### DESCRIPTION OF EMBODIMENTS

Technical solutions in embodiments of this disclosure are clearly and completely described in the following with reference to the accompanying drawings in the embodiments of this disclosure. Apparently, the described embodiments are merely some rather than all of the embodiments of this disclosure. All other embodiments obtained by a person of ordinary skill in the art based on the embodiments of this disclosure without creative efforts shall fall within the protection scope of this application.

A resource processing method provided in embodiments of this disclosure is applicable to an application environment shown in FIG. 1. A terminal 102 communicates with a server 104 via a network. A data storage system may store data that the server 104 needs to process. The data storage system may be integrated on the server 104, or may be placed on a cloud or another server. The terminal 102 may transmit a digital account creation request to the server 104, so that the server 104 may create a digital account in response to the creation request, create a signature private key and a signature public key that are bound with the digital account, and deliver the signature private key to the terminal 102. In this way, the terminal 102 may generate, based on the signature private key, a resource processing request including a digital signature. When receiving the resource processing request including the digital signature, the server 104 may verify the digital signature by using the signature public key bound with the digital account, and process a virtual resource in the digital account based on the resource processing request after the verification succeeds. The terminal 102 may be but is not limited to any desktop computer, a notebook computer, a smartphone, a tablet computer, an Internet of Things device, and a portable wearable device. The Internet of Things device may be a smart speaker, a smart television, a smart air conditioner, a smart in-vehicle device, or the like. The portable wearable device may be a smartwatch, a smart band, a head-mounted device, or the like. The server 104 may be implemented by an independent server or a server cluster including multiple servers, or may be a cloud server.

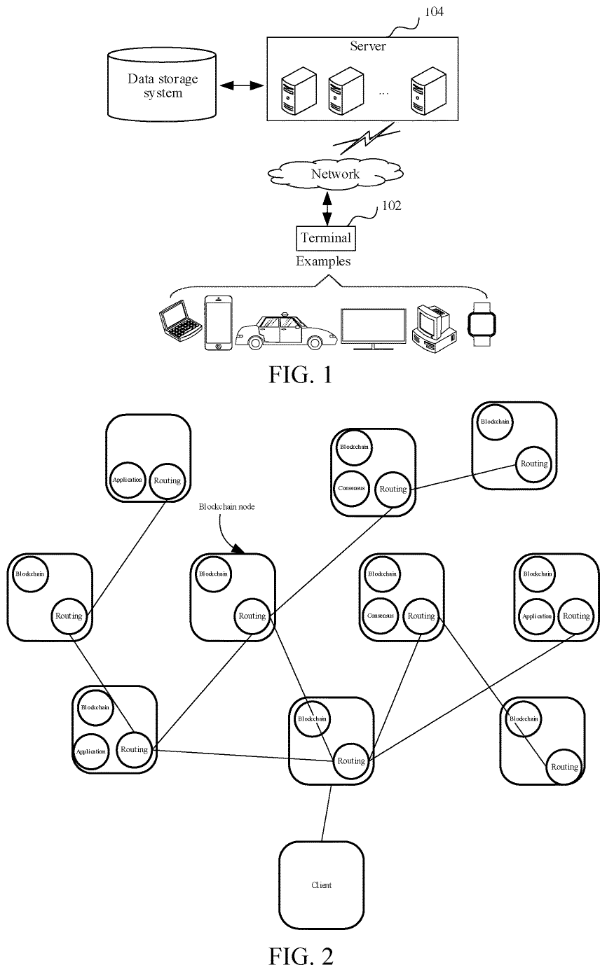

This application relates to a blockchain technology. For example, a shared account in this application is a shared account that is set based on a blockchain. A blockchain network in the embodiments of the present invention may be a network generated based on a distributed system. FIG. 2 is an optional schematic structural diagram of a distributed system used in a blockchain network according to an embodiment of the present disclosure. The blockchain network includes multiple nodes (computing devices in any form in an access network, such as a server and a user terminal). A peer-to-peer (P2P) network is formed between the nodes. A peer-to-peer protocol is an application-layer protocol running over a transmission control protocol (TCP). In the distributed system, any machine like a server or a terminal may be added to become a node. The node includes a hardware layer, an intermediate layer, an operating system layer, and an application layer. Functions of each node in the blockchain network include:

(1) routing: a basic function of a node, and configured for supporting communication between nodes.

In addition to the routing function, the node may further have the following function:

(2) application: deployed in a blockchain, and configured for implementing a specific service based on an actual service requirement, recording data related to function implementations to form recorded data, including a digital signature in the recorded data to represent a source of task data, and transmitting the recorded data to another node in a blockchain system, so that the another node adds the recorded data to a temporary block when a source and integrity of the recorded data are successfully verified.

This application further relates to a cloud technology. For example, a smart contract server in this application may be a cloud server that provides a cloud computing service. The cloud technology refers to a hosting technology that unifies a series of resources such as hardware, software, and a network in a wide area network or a local area network to implement computation, storage, processing, and sharing of data.

The terms “first” and “second” and similar terms used in this application do not indicate any order, quantity, or significance, but are used to only distinguish different components. Unless the context clearly indicates otherwise, singular forms “one”, “a”, or “the” and similar expressions do not indicate a limitation of quantity, but rather indicate existence of at least one. Quantities such as “multiple” or “multiple copies” mentioned in various embodiments of this disclosure all refer to a quantity of “at least two”. For example, “multiple” refers to “at least two”, and “multiple copies” refers to “at least two copies”.

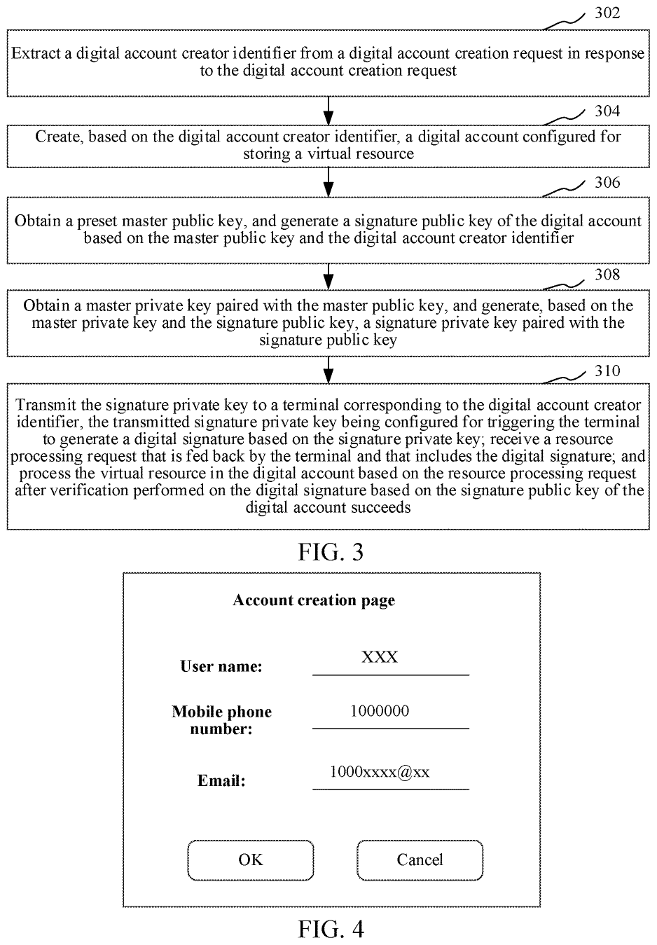

In an embodiment, as shown in FIG. 3, a resource processing method is provided. Descriptions are provided by using an example in which the method is applied to the server in FIG. 1. The method includes the following operations.

Operation 302: Extract a digital account creator identifier from a digital account creation request in response to the digital account creation request.

Specifically, when a digital account needs to be created, a digital account creator may trigger a terminal to generate a digital account creation request, and transmit the digital account creation request to the server, so that the server can receive the digital account creation request. For example, refer to FIG. 4. The terminal corresponding to the digital account creator may display an account creation page shown in FIG. 4, so that the digital account creator may enter, on the account creation page, information required to create the digital account, for example, may enter a digital account creator identifier. When the digital account creator clicks an OK control on the account creation page, the terminal corresponding to the digital account creator may generate a digital account creation request carrying the digital account creator identifier. The digital account creator identifier refers to information identifying the digital account creator. For example, the digital account creator identifier may be a user name, a mobile phone number, or an email. FIG. 4 is a schematic diagram of the account creation page according to an embodiment.

The digital account creation request is configured for creating the digital account. For the digital account, each unit of virtual resource stored therein has a distinct resource identifier. The resource identifier refers to information that uniquely identifies the unit of virtual resource. A quantity of resources corresponding to each unit of virtual resource may vary. For example, a virtual resource of 100 resources may be considered as one unit of resource, or a resource of one resource may be considered as another unit of virtual resource. When a single unit of virtual resource flows in different digital accounts, an identifier of the unit of virtual resource does not change with the digital accounts. The digital account may be a common account owned by a single digital account creator, or may be a shared account jointly owned by multiple digital account creators. In addition, the virtual resource stored in the digital account is a virtual resource uniformly delivered by a central management agency, and only the central management agency can split one unit of virtual resource to obtain multiple units of virtual resources, and assign different identifiers to the multiple units of virtual resources. Stored virtual resources can be exchanged between digital accounts. For example, two units of virtual resources each including 50 resources in a digital account A may be exchanged with one unit of virtual resource of 100 resources in a digital account B. When the two units of virtual resources each including 50 resources are exchanged from the digital account A to the digital account B, identifiers of the two units of virtual resources each including 50 resources do not change with the digital account. The virtual resource is a collective name of materials that may be used or can be used. The virtual resource may be a computer resource or currency. The computer resource may include a central processing unit (CPU) resource, a time slice resource, a graphics processing unit (GPU) resource, and the like.

In an embodiment, when a to-be-created digital account is a shared account, the digital account creator may click a shared account create control, so that the terminal corresponding to the digital account creator may display an account creation page. Then, the digital account creator may enter multiple digital account creator identifiers on the account creation page. For example, the digital account creator (a user A) may enter an email and a mobile phone number of the user A, and may further enter an email and a mobile phone number of a user B. Then, the terminal corresponding to the digital account creator may generate a digital account creation request based on the multiple entered digital account creator identifiers. In the foregoing example, the user A and the user B are users jointly owning the shared account.

Alternatively, the user A may enter a digital account creator identifier of the user A on the account creation page, for example, enter the email and the mobile phone number of the user A, and click an account identifier add control, so that a terminal corresponding to the user A can generate a digital account creation request carrying the digital account creator identifier of the user A and transmit the digital account creation request to the server, for example, generate a digital account creation request A, and transmit the digital account creation request A to the server. The terminal corresponding to the user A may further generate an account identifier addition request carrying a request identifier of the digital account creation request, for example, generate an account identifier addition request carrying a request identifier of the digital account creation request A. The user A may select, from a friend list, a next user filling in a digital account creator identifier, for example, select the user B. Then, the terminal corresponding to the user A may transmit the account identifier addition request to the user B. When a terminal corresponding to the user B receives the account identifier addition request, the terminal corresponding to the user B may display an account creation page. The user B may enter a digital account creator identifier of the user B on the account creation page, for example, enter the email and the mobile phone number of the user B. Then, the terminal corresponding to the user B may generate a digital account creation request that carries the digital account creator identifier of the user B and the request identifier in the received digital account creation request, for example, generate a digital account creation request B that carries the request identifier of the digital account creation request A and the digital account creator identifier of the user B, and transmit the digital account creation request B to the server. Certainly, the user B may further trigger the terminal of the user B to generate an account identifier addition request and transmit the account identifier addition request to another digital account creator (for example, a user C). Further, after a last digital account creator enters a digital account creator identifier of the last digital account creator on a creation page, the last digital account creator may click a complete control, and a terminal corresponding to the last digital account creator may generate, based on a request identifier in a received account identifier addition request and the identifier of the last digital account creator, a digital account creation request corresponding to the last digital account creator, and add an end identifier to the digital account creation request corresponding to the last digital account creator. When the server receives the digital account creation request added with the end identifier, the server may sequentially searches for, based on the digital account creation request added with the end identifier, digital account creation requests related to the digital account creation request added with the end identifier, extracts digital account creator identifiers from the found digital account creation requests, and creates a shared digital account based on the extracted digital account creator identifiers. For example, a digital account creator identifier of the user C and an identifier of the digital account creation request B may be extracted from a digital account creation request C. The server finds the digital account creation request B based on the identifier of the digital account creation request B, and extracts the digital account creator identifier of the user B and the identifier of the digital account creation request A from the digital account creation request B. The server finds the digital account creation request A based on the identifier of the digital account creation request A, and extracts the digital account creator identifier of the user A from the digital account creation request A. Thus, all digital account creator identifiers are obtained.

Operation 304: Create, based on the digital account creator identifier, a digital account configured for storing a virtual resource.

Specifically, the server creates the digital account based on the digital account creator identifier, for example, encrypts the digital account creator identifier to generate an encrypted account name. The encrypted account name is an account name of the digital account. In an embodiment, the server may further create a smart contract for the created digital account, to manage the created digital account based on the smart contract. The smart contract is a computer protocol intended to disseminate, verify, or execute a contract in an informatization manner. The smart contract allows trusted transactions without a third party, and these transactions can be viewed and are irreversible. The concept of the smart contract was first put forward by Nick Szabo in 1994. Commonly speaking, the smart contract is a specified computer program. The program can automatically execute trusted contract content without participation of a third-party intermediate organization, and all operations can be publicly checked and are irreversible. For example, a smart contract parameter may be set, and the smart contract of the digital account is generated based on the smart contract parameter. When a total quantity of resources in the digital account needs to be managed and controlled by using the smart contract, the smart contract parameter may be a resource management and control condition, resource management and control duration, or the like.

Operation 306: Obtain a preset master public key, and generate a signature public key of the digital account based on the master public key and the digital account creator identifier.

Specifically, when the server creates the digital account, the server may further generate the signature public key based on the digital account creator identifier and the preset master public key. For example, the server may obtain a preset signature public key generation algorithm, and generate the signature public key based on the digital account creator identifier and the master public key by using the signature public key generation algorithm. The preset master public key is a preset public key. In an embodiment, different servers may be preset with different master public keys, or different digital account creators may be preset with different master public keys. Alternatively, the preset master public key in the server may be updated at a preset time interval. This is not limited in this embodiment.

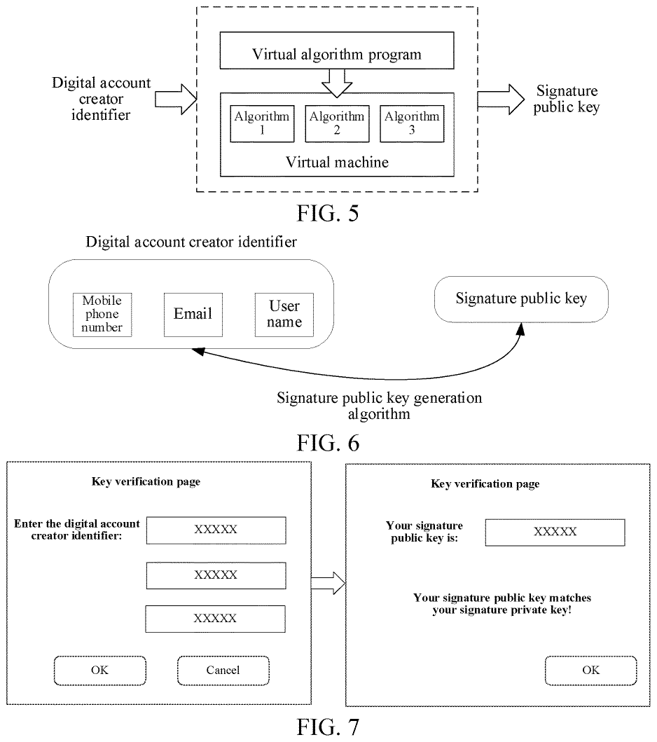

In an embodiment, refer to FIG. 5. A virtual machine runs in a server, and a signature public key may be generated via the virtual machine. For example, multiple signature public key generation algorithms may be preset. When the signature public key needs to be generated, one signature public key algorithm may be sifted out from the multiple signature public key generation algorithms, and the sifted-out signature public key algorithm is referred to as a target signature public key algorithm. Further, algorithm source code corresponding to the target signature public key algorithm may be obtained, and the algorithm source code is compiled, based on a preset virtual machine instruction set, into a virtual algorithm program recognizable by the virtual machine. The virtual algorithm program is run via the virtual machine, to generate the signature public key by using the digital account creator identifier. FIG. 5 is a schematic diagram of generating the signature public key according to an embodiment.

In an embodiment, a server identifier of a current server may be obtained, and a target signature public key algorithm matching a running capability of the server is selected from multiple encryption algorithms based on the server identifier. Alternatively, the target signature public key algorithm may be randomly selected from the multiple encryption algorithms. In an embodiment, algorithm source code may be compiled based on a system instruction set matching an operating system of the server, to obtain intermediate code including preset system instructions in the system instruction set. Based on a mapping relationship between a preset virtual machine instruction set and the system instruction set, the intermediate code is converted and compiled into a virtual algorithm program recognizable by a virtual machine.

In this embodiment of this disclosure, the virtual machine instruction set is preset. The virtual machine instruction set is a non-universal instruction set, for example, an instruction set specially developed for a specific application program. Each virtual machine instruction in the preset virtual machine instruction set can correspond to a system instruction in the system instruction set. Therefore, the server may convert and compile, based on the mapping relationship between the preset virtual machine instruction set and the system instruction set, the intermediate code into the virtual algorithm program recognizable by the virtual machine.

In an embodiment, the server may alternatively generate a signature public key based only on a digital account creator identifier. For example, refer to FIG. 6. The server may generate a signature public key based on a signature public key generation algorithm by using information such as a mobile number, an email, and a user name of a digital account creator. FIG. 6 is a schematic diagram of generating the signature public key according to another embodiment.

In an embodiment, when a master public key is generated, the master public key may be stored in a blockchain, and is subject to a consensus of consensus nodes in the blockchain.

Operation 308: Obtain a master private key paired with the master public key, and generate, based on the master private key and the signature public key, a signature private key paired with the signature public key.

Specifically, when the signature public key needs to be generated, the server may obtain the preset master private key, and generate the signature private key based on the master private key and the signature public key. The master private key is a private key paired with the foregoing master public key, and a corresponding master private key may be generated when the master public key is generated.

In an embodiment, the server may generate the signature private key by using the following formula: ID_Pri=s*ID_Pub, where s is a master private key, and ID_Pub is a signature public key.

In an embodiment, the server may alternatively trigger the virtual machine to generate the master private key. For a manner of generating the master private key via the virtual machine, refer to the foregoing manner of generating the master public key via the virtual machine.

In an embodiment, a signature private key may be generated in a trusted execution environment (TEE) of the server. For example, the server uses a Trusted Execution Environment (TEE) as a hardware basis, and runs generation logic of the signature private key in the TEE. A signature private key generation component is configured to generate the signature private key based on a signature public key and a master private key. The trusted execution environment protected by a hardware chip is referred to as a TEE. The TEE has an inherent signature key for protecting data privacy and authenticating data integrity, source reliability, and the like; and has a memory access control mechanism and a memory encryption mechanism with the outside. To be specific, the outside includes an operating system, and has no access permission to memory space in a trusted computing domain. The TEE has a remote authentication mechanism, configured for proving, to a remote end, that logic and the like running in a trusted computing environment have not been tampered with. An effect achieved through trusted computing is that data and program logic in the trusted computing domain cannot be snooped by an external environment without an active output.

Operation 310: Transmit the signature private key to a terminal corresponding to the digital account creator identifier, the transmitted signature private key being configured for triggering the terminal to generate a digital signature based on the signature private key; receive a resource processing request that is fed back by the terminal and that includes the digital signature; and process the virtual resource in the digital account based on the resource processing request after verification performed on the digital signature based on the signature public key of the digital account succeeds.

Specifically, after generating the signature private key paired with the signature public key, the server may transmit the generated signature private key to the terminal corresponding to the digital account creator identifier in a secure manner, so that the terminal can securely store the received signature private key. In an embodiment, after the signature private key is generated, that is, creation of the digital account has been completed, the server may transmit digital account creation success information and the signature private key together to the terminal, so that the terminal can display the digital account creation success information to the digital account creator, and securely store the signature private key.

In an embodiment, when the digital account creator expects to process the virtual resource in the digital account, for example, when the digital account creator expects to add a virtual resource to the digital account, the digital account creator may trigger the terminal to display a virtual resource information collection page, so that the digital account creator may enter related information on the virtual resource information collection page, for example, enter a quantity of virtual resources that are expected to be added and the virtual resources. Then, the terminal may sign, based on the signature private key, the information entered by the digital account creator, to generate the digital signature, generate the resource processing request based on the digital signature, and transmit the resource processing request to the server. When the server receives the resource processing request, the server may verify the digital signature by using the signature public key paired with the delivered signature private key, and process the virtual resource in the digital account in response to the resource processing request after the verification succeeds. For example, the server may transfer, from a virtual resource source to the digital account, the virtual resources that are expected to be added.

In an embodiment, refer to FIG. 7. The digital account creator may further enter the digital account creator identifier into the terminal, for example, enter the mobile phone number or the email, so that the terminal can transmit the digital account creator identifier to the server, and the server can determine the corresponding signature public key based on the received digital account creator identifier. For example, the server may obtain a preset signature public key generation algorithm, generate the signature public key based on the received digital account creator identifier by using the signature public key generation algorithm, and return the signature public key to the terminal, so that the terminal displays the received signature public key. Further, after receiving the signature public key, the terminal may further verify the received signature public key by using a stored signature private key, and display a verification result. FIG. 7 is a schematic diagram of displaying the signature public key according to an embodiment. The digital account creator may enter one digital account creator identifier, or may enter multiple digital account creator identifiers. When entering only one digital account creator identifier, the server may find, based on the entered digital account creator identifier, a remaining digital account creator identifier used when the digital account is created.

In the foregoing resource processing method, when the digital account creation request is received, the digital account creator identifier is extracted from the digital account creation request, and the digital account and the signature public key of the digital account may be generated based on the digital account creator identifier. The signature public key is generated, the signature private key may be generated based on the signature public key, and further, the signature private key may be transmitted to the terminal corresponding to the digital account creator identifier, so that the terminal corresponding to the digital account creator identifier may generate, based on the received signature private key, the resource processing request including the digital signature, and the server may process the virtual resource in the digital account in response to the resource processing request when verification performed on the digital signature by using the signature public key succeeds. Because the signature public and private keys are generated based on the signature public key generation algorithm and the digital account identifier, in this application, a correspondence between the digital account creator identifier and the signature public and private keys does not need to be additionally maintained, that is, the digital account creator identifier and the signature public and private keys do not need to be correspondingly stored by using a centralized database. When the signature public key corresponding to the digital account creator identifier needs to be determined, in this application, the signature public key can be derived by processing the digital account creator identifier based on the signature public key generation algorithm. Compared with a conventional technology in which the digital account creator identifier and the public and private keys need to be stored in the centralized database, in this application, the digital account creator identifier and the signature public and private keys do not need to be correspondingly stored by using the centralized database. Therefore, a security problem of the digital account that is caused because the centralized database is attacked to steal information is reduced, to improve security of the digital account.

In addition, a pair including the signature public and private keys is additionally generated based on the master public and private keys, so that the virtual resource in the digital account can be subsequently processed based on the signature public and private keys instead of the master public and private keys. In this way, even if the master public and private keys are leaked, security of the digital account is not affected. In this way, the security of the digital account is further improved.

In an embodiment, the method further includes an operation of generating the master public and private keys. The operation of generating the master public and private keys includes: generating a random number and using the random number as the master private key; obtaining a first elliptic curve, and determining a first base point on the first elliptic curve; and performing a point multiplication operation on the first base point and the master private key, to obtain the master public key paired with the master private key.

Specifically, before the signature public key and the signature private key are generated, a pair including the master public and private keys may be generated. When the master public and private keys need to be generated, the server may generate a random number, and use the random number as the master private key. Further, the server may obtain an elliptic curve. The elliptic curve is referred to as a first elliptic curve. The server may determine a base point (also referred to as a generator) on the first elliptic curve, where the base point on the first elliptic curve is referred to as a first base point, perform a point multiplication operation on the first base point and the master private key, to obtain a master private key multiple point, and use the master private key multiple point as the master public key paired with the master private key.

In an embodiment, the server generates a random number s^{∈}[1, N−1](1≤s≤N−1) as the master private key, and calculates an element P=[s]*G on the first elliptic curve as the master public key. The first elliptic curve defines an additive cyclic group of prime order N (N is a prime number). G is a base point on the first elliptic curve. [s]*G represents an s-multiple (scalar multiplication) of the base point G by s. The random number may be a positive integer.

The base point is a point on the elliptic curve, and is a basis for determining a multiple point on the elliptic curve. Assuming that there is an elliptic curve in a coordinate system (an X-axis and a Y-axis), there is a base point on the elliptic curve, and a tangent line of the base point intersects the elliptic curve, a point symmetric to the intersection point with respect to the X-axis of the coordinate system is a double point of the base point. A straight line passing through the double point of the base point and the base point further intersects the elliptic curve, and a point symmetric to the intersection point with respect to the X-axis of the coordinate system is a triple point. The rest may be deduced by analogy. The point multiplication operation is a calculation manner of calculating a multiple point, and the point multiplication operation may be performed by using a quick power algorithm and a Qin Jiushao algorithm.

In the foregoing embodiments, the master public key and the master private key are generated, so that the signature public key and the signature private key may be subsequently generated based on the master public key and the master private key.

In an embodiment, the generating a signature public key of the digital account based on the master public key and the digital account creator identifier includes: concatenating multiple digital account creator identifiers and the master public key when the multiple digital account creator identifiers are extracted from the digital account creation request, to obtain a concatenated identifier; performing a hash operation on the concatenated identifier, to obtain a hash identifier; and generating the signature public key based on the hash identifier.

Specifically, the digital account creator may enter multiple digital account creator identifiers on the account creation page, for example, enter an email, a mobile phone number, and a user name, so that the terminal corresponding to the digital account creator may generate a digital account creation request carrying the multiple digital account creator identifiers. When the server receives the digital account creation request, the server may extract the multiple digital account creator identifiers from the digital account creation request, for example, extract the email, the mobile phone number, and the user name. Then, the server may concatenate the master public key and the multiple extracted digital account creator identifiers, for example, concatenate the email, the mobile phone number, the user name, and the master public key, to obtain a concatenated identifier.

Further, the server performs a hash operation on the concatenated identifier, to obtain a hash identifier. For example, the server may perform the hash operation on the concatenated identifier by using a preset hash algorithm, to obtain the hash identifier, and then generate a signature public key based on the hash identifier.

In this embodiment, when there are multiple digital account creator identifiers, a concatenated identifier may be obtained by concatenating the multiple digital account creator identifiers, so that a signature public key may be subsequently obtained based on the concatenated identifier. In this way, the signature public key is generated. Compared with a manner in which a signature public key can be generated by using only one digital account creator identifier, in this embodiment, even if multiple digital account creator identifiers are received, the signature public key may be obtained based on the multiple digital account creator identifiers, to greatly improve flexibility of generating the signature public key.

In an embodiment, the generating the signature public key based on the concatenated identifier includes: obtaining a second elliptic curve, and determining a second base point on the second elliptic curve; and fusing the second base point and the hash identifier based on the second elliptic curve, to obtain the signature public key.

Specifically, when needing to generate the signature public key based on the concatenated identifier, the server may obtain the second elliptic curve, and determine the base point (also referred to as a generator) on the second elliptic curve. The base point on the second elliptic curve is referred to as the second base point. Further, the server fuses the second base point and the hash identifier based on the second elliptic curve, to obtain the signature public key. For example, the server may obtain the signature public key by using a formula: ID_PUB=H(ID)*G. H is a hash function, ID is the concatenated identifier, G is the second base point on the second elliptic curve, namely, the generator, and ID_PUB is the signature public key.

In the foregoing embodiment, the second base point is determined, so that the signature public key can be quickly obtained based on the second base point, to improve generation efficiency of the signature public key.

In an embodiment, the generating, based on the master private key and the signature public key, a signature private key paired with the signature public key includes: multiplying the master private key by the signature public key, to obtain the signature private key paired with the signature public key.

In an embodiment, the transmitting the signature private key includes: obtaining a verification code, and determining an encryption key generation algorithm; processing the verification code by using the encryption key generation algorithm, to obtain a first encryption key; encrypting the signature private key based on the first encryption key, to obtain an encrypted private key; and transmitting the encrypted private key and the verification code to the terminal corresponding to the digital account creator identifier, the transmitted encrypted private key and verification code being configured for triggering the terminal to decrypt the encrypted private key based on the verification code, to obtain the signature private key.

Specifically, to securely deliver the signature private key, the server may generate a verification code. For example, the server may generate a random verification code based on a verification code generation algorithm. Further, the server may determine a preset encryption key generation algorithm, process the verification code by using the encryption key generation algorithm, to obtain a first encryption key, and encrypt the signature private key by using the first encryption key, to obtain an encrypted private key. The encryption key generation algorithm may be freely set based on a requirement, and is not limited in this embodiment herein.

Further, the server transmits the first encryption key to the terminal corresponding to the digital account creator identifier. For example, the server transmits, by using a secure link (for example, the Hypertext Transfer Protocol Secure (HTTPS)), the first encryption key and the verification code to the terminal corresponding to the digital account creator identifier. When the terminal receives the first encryption key and the verification code, the terminal may decrypt the first encryption key by using the verification code, to obtain the signature private key.

In this embodiment, because specific content of the verification code is random, randomness of encryption may be improved by encrypting the signature private key by using the verification code, to improve an encryption effect. The encrypted signature private key is transmitted to the terminal, so that transmitting security of the signature private key can be improved, and a risk that the signature private key is stolen in a transmitting process can be reduced.

In an embodiment, the processing the verification code by using the encryption key generation algorithm, to obtain a first encryption key includes: obtaining a salt, and generating an initial key block for a current round based on the verification code and the salt; obtaining a key block for a previous round, and concatenating the initial key block for the current round and the key block for the previous round, to obtain a key block for the current round; entering a next round when a byte length of the key block for the current round does not satisfy a preset length condition, using/treating the next round as the current round, and returning to continue to perform the operation of generating an initial key block for a current round based on the verification code and the salt until a byte length of a key block for the current round satisfies the preset length condition; and using a key block for a last round as the first encryption key. In this embodiment, an iteration process is used. The iteration continues until byte length of a key block for the current round satisfies the preset length condition. That is, the termination condition is that byte length of a key block for the current round satisfies the preset length condition. In some implementations.

In cryptography, a particular character string is inserted at any fixed position of a password, so that a result obtained after hashing does not conform to a hash result using the original password. This process is referred to as “salting”. The particular character string is a salt.

In this embodiment, when the verification code needs to be processed by using the encryption key generation algorithm or more general encryption key algorithm, to generate the first encryption key, the server may obtain a preset salt. The salt may be a character string. Further, the server generates the initial key block for the current round based on the verification code and the salt.

In an embodiment, the salt is a preset fixed value that remains constant across all rounds of key block generation. That is, the same salt is used as an input when generating the initial key block for each round. Within each round, the server concatenates the salt with encoded data to obtain a target salt, and uses the target salt only in generating the 1st hash key block for that round. The encoded data is obtained by encoding a round index number i (for example, i=1, 2, 3, . . . ), where i is incremented with each round. Accordingly, although the base salt remains fixed, the target salt differs from round to round because the encoded index i varies, thereby ensuring that the initial key block generated for each round is distinct. This design prevents the same initial key block from being generated for different rounds even when the same verification code and the same salt are used as inputs, thereby improving the complexity and unpredictability of the first encryption key.

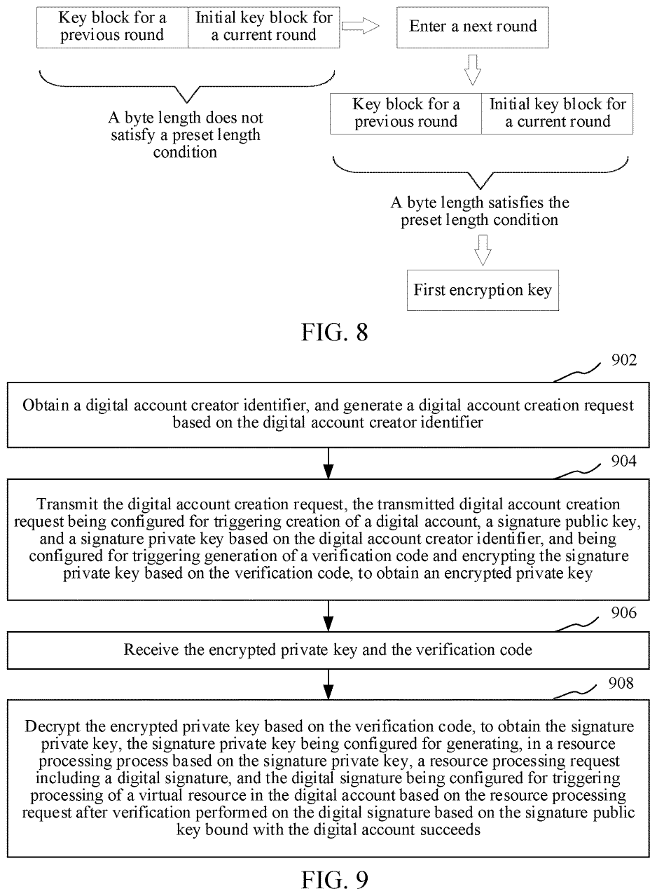

The server may obtain the key block generated for the previous round, and concatenate the key block generated for the previous round and the initial key block generated for the current round, to obtain the key block for the current round. For example, refer to FIG. 8. The server may place the initial key block generated for the current round (for example, the 5^{th} round) after the key block generated for the previous round (for example, the 4^{th} round), to obtain the key block generated for the current round. Further, a byte length of a to-be-generated first encryption key may be preset, and a byte length of the key block generated for the current round is compared with the byte length of the to-be-generated first encryption key. When the byte length of the key block generated for the current round is less than the byte length of the to-be-generated first encryption key, it is determined that the byte length of the key block generated for the current round does not satisfy the preset length condition. In this case, a process of generating the key block for the next round needs to be performed. The server enters the next round (for example, the 6^{th} round), uses the next round as the current round, and returns to continue to perform the operation of generating an initial key block for a current round based on the verification code and the salt until the byte length of the key block for the current round satisfies the preset length condition. For example, the server generates the initial key block for the 6^{th} round, concatenates the initial key block for the 6^{th} round and the key block for the 5^{th} round, to obtain a key block for the 6^{th} round. If a byte length of the key block for the 6^{th} round is equal to the byte length of the to-be-generated first encryption key, the server determines that the byte length of the key block for the current round satisfies the preset length condition. In this case, generation of the key block ends.

Further, when a key block generation process ends, the server may use the key block for the last round as the first encryption key, for example, use the key block for the 6^{th} round as the first encryption key. FIG. 8 is a schematic diagram of generating the first encryption key according to an embodiment.

In an embodiment, the server may obtain a preset byte length as a byte length of a to-be-generated first encryption key, determine a byte length of an initial key block generated for a single round, and divide the byte length of the to-be-generated first encryption key by the byte length of the initial key block generated for the single round, to obtain rounds that are to be performed. The server may obtain the first encryption key after performing the rounds. When a division result obtained by dividing the byte length of the to-be-generated first encryption key by the byte length of the initial key block generated for the single round is not an integer, the server may adjust the byte length of the to-be-generated first encryption key, or adjust the byte length of the initial key block generated for the single round, to cause the division result to be a positive integer. In this way, flexibility of generating the first encryption key is improved.

In the foregoing embodiment, complexity of the first encryption key may be increased by performing multiple rounds of key block generation processes, so that a complex encrypted private key is obtained by using the complex first encryption key, to reduce a probability that the encrypted private key is cracked, and improve security of the encrypted private key.

In an embodiment, the generating an initial key block for a current round based on the verification code and the salt includes: obtaining encoded data, and concatenating the salt with the encoded data, to obtain a target salt; performing a hash operation on the verification code and the target salt, to obtain the 1^{st} hash key block; generating a current hash key block based on the verification code and a previous hash key block in a generation process of the current hash key block starting from a generation process of the 2^{nd} hash key block; using a generation process of a next hash key block as the generation process of the current hash key block, and returning to continue to perform the operation of determining a current hash key block based on the verification code and a previous hash key block until a preset quantity of hash key blocks are generated; and using a last hash key block as the initial key block for the current round.

Specifically, in a single round (a single iteration), the server may obtain preset encoded data, and concatenate the salt and the preset encoded data, to obtain a target salt. The encoded data is data that is obtained by encoding a preset number and that has a preset byte length, for example, is a 32-bit number obtained by encoding i. The server performs a hash operation on the target salt, to obtain the 1^{st} hash key block.

In a generation process of a current hash key block key that starts from a generation process of the 2^{nd} hash key block, the server may generate the current hash key block based on the verification code and a previous hash key block. For example, for the generation process of the 2^{nd} hash key block, the server generates the 2^{nd} hash key block based on the verification code and the 1^{st} hash key block. For a generation process of the 3^{rd} hash key block, the server generates the 3^{rd} hash key block based on the verification code and the 2^{nd} hash key block. Further, the server determines whether the preset quantity of hash key blocks are generated. If the preset quantity of hash key blocks are not generated, the server enters a generation process of a next hash key block, and returns to continue to perform the operation of determining a current hash key block based on the verification code and a previous hash key block until the preset quantity of hash key blocks are generated.

When the preset quantity of hash key blocks are generated, the server uses the last hash key block as the initial key block for the current round. For example, if the preset quantity is 10, after 10 hash key blocks are generated, the server continues to generate hash key blocks, and uses the 10^{th} hash key block as an initial key block for a current round, so that the server may subsequently generate a key block for the current round based on the initial key block for the current round.

In an embodiment, the operation of generating a current hash key block based on the verification code and a previous hash key block includes: performing the hash operation on the verification code and the previous hash key block, to obtain the current hash key block.

In an embodiment, the operation of generating a first encryption key includes:

using the verification code and the salt as input parameters, and then performing repeated operations, to finally generate the first encryption key Key.

The first encryption key may be generated by using the following formula: Key=F1(Code, Salt, C, kLen), where

C is a quantity of iterations, kLen is a byte length of the first encryption key, and F1 is a function configured for generating the first encryption key.

A value of the first encryption key Key is obtained by concatenating more than one initial key block. A quantity of initial key blocks is kLen/hLen, where hLen is a byte length of the initial key block. In other words, if a result output through the function F1 is shorter than the expected first encryption key, the length of the first encryption key needs to be satisfied by concatenating multiple results, as shown in the following formula:

Key=T1∥T2 . . . ∥T (kLen/hLen), where T1, T2, . . . are all initial Key blocks. Each initial key block is obtained according to a function F2.

The operation of obtaining the initial key block according to the function F2 may be implemented according to the following formula: Ti=F2(Code, Salt, R, i). In the function F2, R (R is an integer) operations are performed to obtain the initial key block, i is a preset number, and the encoded data may be obtained by encoding i. For the first time, the function F2 concatenates the salt and the 32-bit number that is obtained by encoding i, to obtain the target salt, and obtains the 1^{st} hash key block by using the target salt and the verification code. That is, P1=H(Code, Salt∥INT_32_BE (i)), where H is a hash operation performed by using Code and Salt∥INT_32_BE (i) as inputs, to obtain an output P1.

In a subsequent process of generating R-1 hash key blocks, a current hash key block is obtained by using a previously obtained hash key, that is, P2=H(Code, P1), U3=H(Code, P2).

When the last hash key block is obtained, the last hash key block is used as the initial key block. For example, PR is used as an initial key block generated for a round.

In the foregoing embodiment, a generated hash key block may be more complex by generating hash key blocks for multiple rounds, so that a more complex initial key block is obtained based on the more complex hash key block, and a more complex first encryption key is obtained based on the more complex initial key block.

In an embodiment, the method further includes: receiving a resource processing request including the digital signature; verifying the digital signature by using the signature public key; responding, after the verification succeeds, to the resource processing request by using the smart contract bound with the digital account, to process the resource in the digital account, to obtain a resource processing result; and storing the resource processing result in a blockchain. The resource processing result stored in the blockchain may be subject to a consensus of consensus nodes in the blockchain.

Specifically, after the terminal corresponding to the digital account creator identifier obtains the signature private key, and when the digital account creator expects to process the virtual resource in the digital account, the terminal corresponding to the digital account creator may obtain resource processing information, so that the terminal may sign the resource processing information, to obtain the digital signature, generate the resource processing request based on the digital signature and the digital account creator identifier, and transmit the resource processing request to the server. When the server receives the resource processing request carrying the digital signature and the digital account creator identifier, the server may derive the signature public key by using the digital account creator identifier, for example, obtain a preset master public key, and calculate a signature public key based on the master public key and the digital account creator identifier in a manner of generating the signature public key, the signature public key obtained through calculation being a derived signature public key, to verify the digital signature by using the derived signature public key. After the verification succeeds, the server may determine, in response to the resource processing request, the digital account corresponding to the digital account creator identifier, and process the virtual resource in the digital account by using the smart contract bound with the digital account.

In an embodiment, it is assumed that resource processing information m is expected to be signed, and a used third elliptic curve parameter is D=(p, a, b, G, n, h), where G is a base point and corresponds to a signature private key KeyS; a random integer number k is generated, where 1≤k≤n−1; a point P=k*G=(x1, y1) is calculated, where (x1, y1) is a fusion point; e=x1 mod n is set, and if e=0, the operation of generating a random integer number k proceeds, where e is a first remainder, and n is an order of the elliptic curve; z=hauh(m) is calculated, where UHA-2 may be selected as a hash function for calculation; u=k⁻¹(z+eEa)(mod n) is calculated, and if u is 0, the operation of generating a random integer number k proceeds, where u is a second remainder; and the first remainder and the second remainder are combined to obtain a digital signature (e, u).

In an embodiment, when the digital signature needs to be verified, the server calculates z=hash(m), where m is the resource processing information, and hash( ) is a hash operation; calculates P1=zu⁻¹ mod n and P2=eu⁻¹ mod n, where n is an order of a third elliptic curve, u is the second remainder in the digital signature, P1 is a third remainder, and P2 is a fourth remainder; calculates a point (x1, y1)=P1G+P2Qa, where Qa is the signature public key, and G is the base point on the third elliptic curve; verifies whether e is equal to x1 mod n, where e is the first remainder in the digital signature; and determines, if e is equal to x1 mod n, that the verification performed on the digital signature succeeds. In this case, the virtual resource in the digital account may be processed in response to the resource processing request by using the smart contract.

In an embodiment, when the resource processing request needs to be responded to by using the smart contract, whether the resource processing request is a valid request may be determined in the smart contract; whether the resource processing request satisfies a condition specified in the smart contract is determined based on resource processing information in the resource processing request; and if the resource processing request satisfies the condition specified in the smart contract, the virtual resource in the digital account is processed based on the resource processing information in the resource processing request. For example, it is specified in the smart contract that a virtual resource of a maximum of 1000 resources is transferred to the digital account each day. If the resource processing information represents that the digital account creator expects to transfer a virtual resource of 10000 resources to the digital account, it is determined that the resource processing request does not satisfy the condition specified in the smart contract. In this case, the server returns a resource processing failure message. If the resource processing information represents that the digital account creator expects to transfer a virtual resource of 500 resources to the digital account, it is determined that the resource processing request satisfies the condition specified in the smart contract. In this case, the server transfers the virtual resource of 500 resources to the digital account, and the server returns a resource processing success message. Further, after the virtual resource in the digital account is processed, the resource processing result may be stored in the blockchain. The resource processing result stored in the blockchain may be subject to a consensus of consensus nodes in the blockchain.

In an embodiment, a manner of processing the virtual resource in the digital account may include increasing or decreasing a quantity of resources of the virtual resource in the digital account. For example, a virtual resource is deposited into the digital account, to increase the quantity of resources of the virtual resource in the digital account, or a virtual resource in the digital account is deducted, to decrease the quantity of resources of the virtual resource in the digital account.

In the foregoing embodiment, responding to the resource processing request after the verification succeeds can greatly improve security of virtual resource processing.

In an embodiment, as shown in FIG. 9, a signature private key obtaining method is provided. Descriptions are provided by using an example in which the method is applied to the terminal corresponding to the digital account creator identifier shown in FIG. 1. The method includes the following operations.

Operation 902: Obtain a digital account creator identifier, and generate a digital account creation request based on the digital account creator identifier.

Specifically, when a digital account needs to be created, a digital account creator may trigger the terminal to display an account creation page, and enter the digital account creator identifier on the account creation page, for example, enter a mobile phone number, an email, and an account name of the digital account creator. In this way, the terminal may obtain the digital account creator identifier in response to the input operation of the digital account creator identifier, and generate the digital account creation request based on the digital account creator identifier.

Operation 904: Transmit the digital account creation request, the transmitted digital account creation request being configured for triggering creation of the digital account, a signature public key, and a signature private key based on the digital account creator identifier, and being configured for triggering generation of a verification code and encrypting the signature private key based on the verification code, to obtain an encrypted private key.

Specifically, when the terminal generates the digital account creation request, the terminal may transmit the digital account creation request to a server, so that the server creates the digital account, the signature public key, and the signature private key based on the digital account creator identifier in the received digital account creation request. After the server generates the signature private key, the server may further generate the verification code, encrypt the signature private key based on the verification code, to obtain the encrypted private key, and transmit the encrypted private key and the verification code to the terminal.

Operation 906: Receive the encrypted private key and the verification code.

Operation 908: Decrypt the encrypted private key based on the verification code, to obtain the signature private key, the signature private key being configured for generating, in a resource processing process based on the signature private key, a resource processing request including a digital signature, and the digital signature being configured for triggering processing of a virtual resource in the digital account based on the resource processing request after verification performed on the digital signature based on the signature public key bound with the digital account succeeds.

Specifically, after the server generates the encrypted private key, the server may transmit the encrypted private key and the verification code together to the terminal, so that the terminal can receive the encrypted private key and the verification code that are transmitted by the server. When the terminal receives the encrypted private key and the verification code, the terminal may decrypt the encrypted private key based on the verification code, to obtain the signature private key, generate the digital signature based on the signature private key in a resource processing process, generate the resource processing request based on the digital signature, and transmit the resource processing request to the server. In this way, when the server receives the resource processing request, the server may verify the digital signature by using the signature public key, and process the virtual resource in the digital account in response to the resource processing request after the verification succeeds.

In the foregoing signature private key obtaining method, the digital account creator identifier may be obtained in response to the input operation of the digital account creator identifier. The digital account creator identifier is transmitted, to trigger the server to create the digital account, the signature public key, and the signature private key, and trigger the server to encrypt the signature private key based on the verification code, to obtain the encrypted private key. The encrypted private key generated by the server and the verification code are obtained, and the encrypted private key may be decrypted by using the verification code, to obtain the signature private key. Then, in the resource processing process, security of resource processing is ensured by using the signature private key. Because the signature public and private keys are generated based on a signature public key generation algorithm and a digital account identifier, in this application, a correspondence between the digital account creator identifier and the signature public and private keys does not need to be additionally maintained, to reduce security problems of the digital account that are caused by attacking and stealing information of a database configured for storing the correspondence between the digital account creator identifier and the signature public and private keys. In this application, the encrypted private key is delivered to the terminal. Compared with directly delivering the signature private key to the terminal, a risk that the signature private key is stolen in a delivery process is reduced, to further improve security of the digital account.

In an embodiment, the decrypting the encrypted private key by using the verification code, and obtaining the signature private key when the decryption succeeds includes: processing the verification code by using the encryption key generation algorithm, to obtain a second encryption key; and decrypting the encrypted private key by using the second encryption key, and obtaining the signature private key when the decryption succeeds.

Specifically, the server processes the verification code by using the encryption key generation algorithm, to obtain the first encryption key, and processes the signature private key by using the first encryption key. Therefore, after the terminal receives the encrypted private key and the verification code that are transmitted by the server, the terminal may process the verification code by using the same encryption key generation algorithm, to obtain the second encryption key, decrypt the encrypted private key based on the second encryption key, and obtain the signature private key after the decryption succeeds. For the process of processing the verification code by using the encryption key generation algorithm to obtain the second encryption key, refer to the foregoing process of processing the verification code by using the encryption key generation algorithm to obtain the first encryption key. In an embodiment, the encryption key generation algorithm may be a symmetric key generation algorithm. Therefore, the generated first encryption key and second encryption key are both symmetric keys. The symmetric key means that the same key is used during encryption and decryption. To be specific, in a correct case, the first encryption key is consistent with the second encryption key, that is, may be configured for both encryption and decryption.

In the foregoing embodiment, the verification code is obtained, and the second encryption key may be generated based on the verification code. In this way, the encrypted private key may be decrypted based on the second encryption key, to obtain the signature private key.

In an embodiment, the method further includes: displaying the verification code and a verification code fill-in box when the verification code transmitted by the server is received; displaying a filled-in verification code in response to a filling operation on the verification code fill-in box; and transmitting the filled-in verification code to the server, the transmitted filled-in verification code being configured for triggering the server to perform consistency comparison between the filled-in verification code and the transmitted verification code, and determining, when the filled-in verification code is consistent with the transmitted verification code, that the signature private key is successfully delivered.

Specifically, when the terminal receives the verification code transmitted by the server, the terminal may further display the verification code and the verification code fill-in box. In an embodiment, the verification code may be specifically a short message service verification code. Further, after the digital account creator views the verification code, the digital account creator may enter the verification code into the verification code fill-in box, and the terminal may display the verification code filled in by the digital account creator in response to the filling operation on the verification code fill-in box. For example, refer to FIG. 10. The digital account creator may fill in a verification code fill-in box 1001 with a verification code. FIG. 10 is a schematic diagram of entering the verification code according to an embodiment.

At the same time, the terminal may further transmit, to the server, the verification code filled in by the digital account creator, so that the server performs consistency comparison between the filled-in verification code and the previously transmitted verification code. When the filled-in verification code is consistent with the transmitted verification code, it is determined that the signature private key is successfully delivered; otherwise, it is determined that there is an error in a process of delivering the signature private key. For example, the server may transmit a verification code “1234” to the terminal. When receiving “1234”, the terminal may display “1234”, so that the digital account creator may enter “1234” into the verification code fill-in box. After the digital account creator enters “1234” into the verification code fill-in box, the terminal may transmit “1234” to the server, so that the server can perform consistency comparison between “1234” that is received with “1234” that is previously transmitted. Because the verification code received by the server and the previously transmitted verification code are both “1234”, the server may determine that the signature private key has been successfully delivered to the terminal. If a verification code “1111” received by the server is inconsistent with the previously transmitted verification code “1234”, it is determined that there is an error in the process of delivering the signature private key. In this case, the server may generate a verification code verification failure message, and transmit the verification code verification failure message to the terminal, so that the terminal displays the verification code verification failure message. Further, the digital account creator may determine, based on the displayed verification code verification failure message, that a signature private key received by the terminal is incorrect.

In this embodiment, the verification code is entered into the verification code fill-in box (code input box), and the entered verification code is transmitted to the server, so that the server can perform consistency comparison between the received verification code and the transmitted verification code, to quickly determine, based on a comparison result, whether the signature private key is successfully delivered to the terminal. For example, delivery verification on the signature private key is implemented, to improve accuracy of the signature private key delivered to the terminal.

In an embodiment, the signature private key being configured for triggering, in the resource processing process, generation of the resource processing request by using the signature private key request including the digital signature includes: displaying multiple items, and displaying, in response to a selection operation for the multiple items, a detail page of an item selected through the selection operation, the detail page displaying an item obtaining control and a quantity of resources required to obtain the item selected through the selection operation; generating, in response to a trigger operation on the item obtaining control, a resource processing packet based on the quantity of resources required to obtain the item selected through the selection operation; and signing the resource processing packet by using the signature private key, to obtain the digital signature, and generating the resource processing request based on the digital signature.

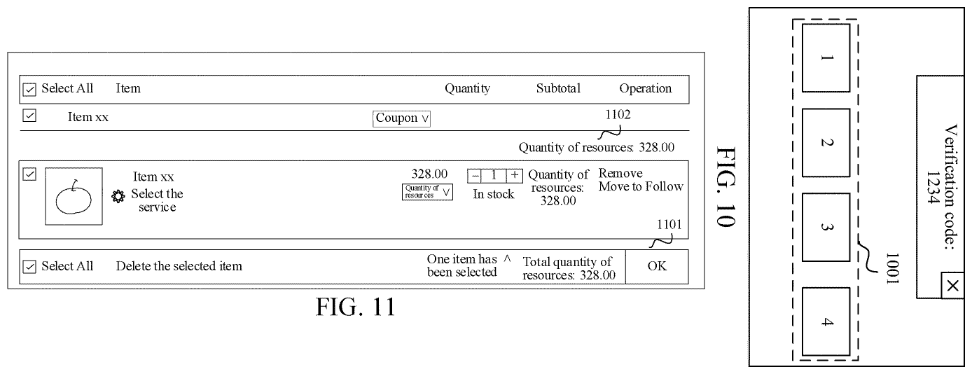

Specifically, when the digital account is successfully created and the signature private key is successfully obtained, the digital account creator may process the virtual resource in the digital account. For example, the digital account creator may trigger the terminal to display multiple items. The digital account creator may select one item from the multiple items through a selection operation, and use the selected item as a target item. Further, the terminal may display a detail page of the target item in response to the selection operation of the digital account creator. On the detail page of the target item, a target item obtaining control and a quantity of resources required to obtain the target item may be displayed. For example, refer to FIG. 11. An OK control 1101 may be displayed. The OK control is the foregoing target item obtaining control. “Quantity of resources: 328” shown by 1102 in FIG. 11 is the foregoing quantity of resources required to obtain the target item. FIG. 11 is a schematic diagram of the detail page according to an embodiment.

When the digital account creator clicks the item obtaining control, in response to the click operation on the item obtaining control, the terminal may use information such as a quantity of obtained target items, a quantity of resources required to obtain the target items, and a resource receiving account as resource processing information, and generate a resource processing packet based on the resource processing information. For example, the terminal may convert the resource processing information based on a preset packet format, to obtain the resource processing packet, or the terminal may directly use the resource processing information as the resource processing packet. Further, the terminal signs the resource processing packet by using the signature private key, to obtain the digital signature. For a manner of signing the resource processing packet by using the signature private key, refer to the foregoing manner of signing the resource processing information by using the signature private key. In this embodiment, details are not described herein again.

Further, after obtaining the digital signature, the terminal may generate a resource processing request based on the digital account creator identifier, the digital signature, and the resource processing packet. That is, the terminal generates the resource processing request carrying the digital account creator identifier, the digital signature, and the resource processing packet, and transmits the resource processing request to the server. After the server receives the resource processing request, the server may derive the signature public key based on the digital account creator identifier, verify the digital signature based on the signature public key, extract a virtual resource of a specific quantity of resources from the digital account corresponding to the digital account creator identifier after the verification succeeds, and flow the extracted virtual resource into the resource receiving account. The specific quantity of resources is a quantity of resources that is determined based on the quantity of resources required to obtain the item selected through the selection operation. For example, when the digital account creator expects to obtain two target items, and a quantity of resources required to obtain a single target item is 100, the server extracts a virtual resource of 200 resources from the digital account, and stores the extracted virtual resource of 200 resources in the resource receiving account. After the resource receiving account receives the virtual resource, a user corresponding to the resource receiving account may transmit the target item to the digital account creator.

In an embodiment, when a quantity of resources of the virtual resource in the digital account is changed, a change result may be stored in a blockchain. For example, when the quantity of resources of the virtual resource in the digital account is reduced by 200 (e.g., dollars), a quantity of remaining resources of the digital account may be stored in the blockchain. The quantity of resources stored in the blockchain may be subject to a consensus of consensus nodes in the blockchain.

In the foregoing embodiment, the signature private key is obtained, and the resource processing packet may be signed by using the signature private key, to obtain the digital signature. The digital signature is obtained, and the virtual resource in the digital account may be processed after verification performed on the digital signature succeeds, to improve security of virtual resource processing.

In an embodiment, after creating a digital account, a server is further configured to: receive a resource processing request, the resource processing request carrying a digital account creator identifier, resource processing information, and a resource processing request digital signature that is generated based on a signature private key corresponding to the digital account creator identifier; determine a corresponding signature public key based on the digital account creator identifier, and verify the resource processing request digital signature by using the signature public key; generate a temporary identifier corresponding to the resource processing request based on the digital account creator identifier and the resource processing information when the verification succeeds; generate, based on the temporary identifier, a temporary public key and a temporary private key that correspond to the resource processing request; transmit the temporary private key, the transmitted temporary private key being configured for triggering, in response to a request confirmation operation triggered for the resource processing request, generation of a request confirmation digital signature based on the temporary private key; and receive the request confirmation digital signature, and process a virtual resource in a digital account corresponding to the digital account creator identifier in response to the resource processing request when verification performed on the request confirmation digital signature by using the temporary public key succeeds.

Specifically, when the digital account creator expects to process the virtual resource in the digital account, the digital account creator identifier may trigger a terminal to generate the resource processing request, and transmit the resource processing request to the server. After the server verifies, by using the signature public key, the resource processing request digital signature carried in the resource processing request, the server may generate the temporary identifier corresponding to the resource processing request based on the digital account creator identifier and the resource processing information. For example, the digital account creator identifier and a resource processing order number may be concatenated to obtain the temporary identifier. Then, the server may generate, based on the temporary identifier, the temporary public key and the temporary private key that correspond to the resource processing request. For a manner of generating the temporary public key and the temporary private key based on the temporary identifier, refer to the foregoing manner of generating the signature public key and the signature private key. The generated temporary private key is delivered to the terminal corresponding to the digital account creator identifier. When the digital account creator triggers the request confirmation operation triggered for the resource processing request, the terminal may sign a confirmation packet by using the temporary private key, generate a request confirmation digital signature, and transmit the request confirmation digital signature to the server, so that the server verifies the request confirmation digital signature by using the temporary public key, and processes the virtual resource in the digital account corresponding to the digital account creator identifier in response to the resource processing request when the verification succeeds. One temporary public key and one temporary private key are generated for each resource processing request. In this way, even if the temporary public key and the temporary private key are leaked, only one resource processing request is affected, and other resource processing requests are not affected. This greatly improves security of resource processing.

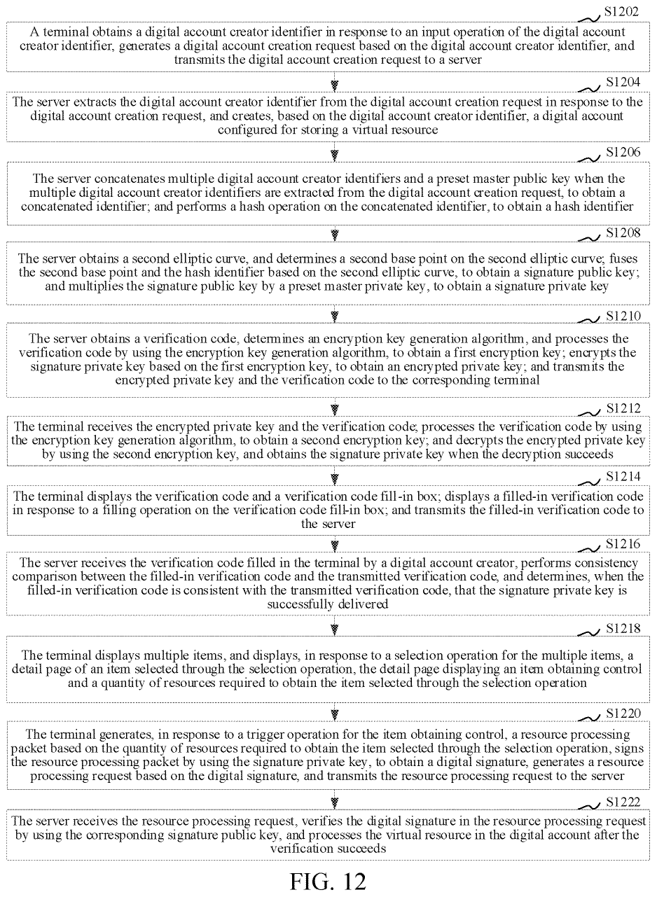

In a specific embodiment, refer to FIG. 12. A virtual resource processing method is provided, and includes the following operations.

Operation 1202: A terminal obtains a digital account creator identifier in response to an input operation of the digital account creator identifier, generates a digital account creation request based on the digital account creator identifier, and transmits the digital account creation request to a server.

Operation 1204: The server extracts the digital account creator identifier from the digital account creation request in response to the digital account creation request, and creates, based on the digital account creator identifier, a digital account configured for storing a virtual resource.

Operation 1206: The server concatenates multiple digital account creator identifiers and a preset master public key when the multiple digital account creator identifiers are extracted from the digital account creation request, to obtain a concatenated identifier; and performs a hash operation on the concatenated identifier, to obtain a hash identifier.

Operation 1208: The server obtains a second elliptic curve, and determines a second base point on the second elliptic curve; fuses the second base point and the hash identifier based on the second elliptic curve, to obtain a signature public key; and multiplies the signature public key by a preset master private key, to obtain a signature private key.

Operation 1210: The server obtains a verification code, determines an encryption key generation algorithm, and process the verification code by using the encryption key generation algorithm, to obtain a first encryption key; encrypts the signature private key based on the first encryption key, to obtain an encrypted private key; and transmits the encrypted private key and the verification code to the corresponding terminal.

Operation 1212: The terminal receives the encrypted private key and the verification code; processes the verification code by using the encryption key generation algorithm, to obtain a second encryption key; and decrypts the encrypted private key by using the second encryption key, and obtains the signature private key when the decryption succeeds.

Operation 1214: The terminal displays the verification code and a verification code fill-in box; displays a filled-in verification code in response to a filling operation on the verification code fill-in box; and transmits the filled-in verification code to the server.

Operation 1216: The server receives the verification code filled in the terminal by a digital account creator, performs consistency comparison between the filled-in verification code and the transmitted verification code, and determines, when the filled-in verification code is consistent with the transmitted verification code, that the signature private key is successfully delivered.

Operation 1218: The terminal displays multiple items, and displays, in response to a selection operation for the multiple items, a detail page of an item selected through the selection operation, the detail page displaying an item obtaining control and a quantity of resources required to obtain the item selected through the selection operation.

Operation 1220: The terminal generates, in response to a trigger operation on the item obtaining control, a resource processing packet based on the quantity of resources required to obtain the item selected through the selection operation, signs the resource processing packet by using the signature private key, to obtain a digital signature, generates a resource processing request based on the digital signature, and transmits the resource processing request to the server.

Operation 1222: The server receives the resource processing request, verifies the digital signature in the resource processing request by using the corresponding signature public key, and processes the virtual resource in the digital account after the verification succeeds.

Although the various operations in the flowcharts in the embodiments as described above are shown in sequence as indicated by arrows, the operations are not necessarily performed in the order indicated by the arrows. Unless otherwise explicitly specified in this specification, execution of the operations is not strictly limited, and the operations may be performed in other sequences. Moreover, at least some of the operations in the flowcharts in the embodiments as described above may include multiple operations or multiple stages. The operations or the stages are not necessarily performed at the same time, but may be performed at different time. The operations or the stages are not necessarily performed in sequence, but may be performed in turn or in alternation with other operations or at least some of the operations or the stages in other operations.

This application further provides an application scenario. The foregoing resource processing method is applied to the application scenario. Specifically, the resource processing method is applied to the application scenario as follows.

When multiple digital account creators expect to create a shared account, each of the multiple digital account creators may enter a digital account creator identifier of the digital account creator into a terminal of the digital account creator, or the multiple digital account creators may enter digital account creator identifiers of the multiple digital account creators into one terminal. After a server obtains the digital account creator identifiers, the server may create, based on the obtained digital account creator identifiers and preset master public and private keys, a shared account and a signature private key and a signature public key that correspond to the shared account. The server fragments the signature private key, to obtain multiple signature private key fragments, and delivers the signature private key fragments to the digital account creators, so that each digital account creator can obtain one signature private key fragment. When a digital account creator expects to process a virtual resource in the shared account, the server may generate a virtual resource processing authorization request, and deliver the virtual resource processing authorization request to the digital account creators. The digital account creator may determine, based on a requirement, whether to authorize processing of the virtual resource in the shared account. If the digital account creator authorizes to process the virtual resource in the shared account, the terminal transmits a signature private key fragment of the digital account creator to a terminal corresponding to a manager. For example, when a digital account creator B authorizes a digital account creator A to process the virtual resource in the shared account, a terminal corresponding to the digital account creator B transmits, to the terminal corresponding to the manager, a signature private key fragment received by the digital account creator B. The terminal corresponding to the manager may restore the signature private key based on the received signature private key fragment. The more signature private key fragments are received, the more likely that the signature private key can be restored. After the terminal corresponding to the manager restores the signature private key, the terminal corresponding to the manager may sign resource processing information by using the restored signature private key, to generate a resource processing request including a digital signature, and transmit the resource processing request to the server, so that the server processes the virtual resource in the shared account in response to the resource processing request based on the signature public key.

This application further provides another application scenario. The foregoing resource processing method is applied to the application scenario. Specifically, the resource processing method is applied to the application scenario as follows.

A digital account may be specifically a digital wallet. A smart contract may be bound with the digital wallet, to constrain use of the digital wallet by a user. The user may purchase an item through the digital wallet.

The foregoing application scenarios are only example illustrations. Application of the resource processing method provided in the embodiments of this disclosure is not limited to the foregoing scenarios.

Based on a same inventive concept, an embodiment of this disclosure further provides a resource processing apparatus, configured for implementing the foregoing resource processing method. An implementation solution provided by the apparatus for resolving a problem is similar to the implementation solution recorded in the foregoing method. Therefore, for specific limitations on one or more following embodiments of the resource processing apparatus, refer to the limitations on the foregoing resource processing method. Details are not described herein again.

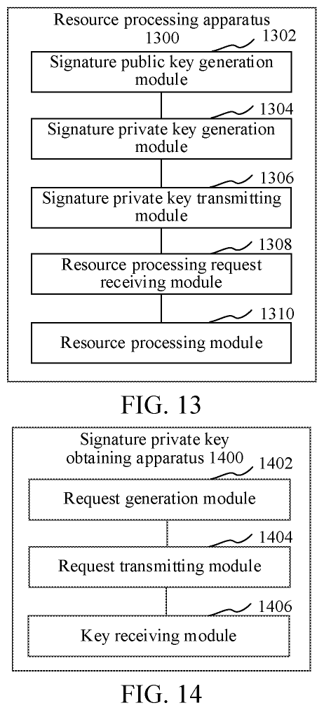

In an embodiment, as shown in FIG. 13, a resource processing apparatus 1300 is provided, including: a signature public key generation module 1302, a signature private key generation module 1304, a signature private key transmitting module 1306, a resource processing request receiving module 1308, and a resource processing module 1310.

The signature public key generation module 1302 is configured to: extract a digital account creator identifier from a digital account creation request in response to the digital account creation request when the digital account creation request is received; create, based on the digital account creator identifier, a digital account configured for storing a virtual resource; and obtain a preset master public key, and generate a signature public key of the digital account based on the master public key and the digital account creator identifier.

The signature private key generation module 1304 is configured to: obtain a master private key paired with the master public key, and generate, based on the master private key and the signature public key, a signature private key paired with the signature public key.

The signature private key transmitting module 1306 is configured to transmit the signature private key to a terminal corresponding to the digital account creator identifier, the transmitted signature private key being configured for triggering the terminal to generate a digital signature based on the signature private key.

The resource processing request receiving module 1308 is configured to receive a resource processing request that is fed back by the terminal and that includes the digital signature.

The resource processing module 1310 is configured to process the virtual resource in the digital account based on the resource processing request after verification performed on the digital signature based on the signature public key of the digital account succeeds.

In an embodiment, the resource processing apparatus 1300 further includes a master public-private key generation module, configured to: generate a random number, and use the random number as the master private key; obtain a first elliptic curve, and determine a first base point on the first elliptic curve; and performing a point multiplication operation on the first base point and the master private key, to obtain the master public key paired with the master private key.

In an embodiment, the signature public key generation module 1302 is further configured to: concatenate multiple digital account creator identifiers and the master public key when the multiple digital account creator identifiers are extracted from the digital account creation request, to obtain a concatenated identifier; perform a hash operation on the concatenated identifier, to obtain a hash identifier; and generate the signature public key based on the hash identifier.

In an embodiment, the signature public key generation module 1302 is further configured to: obtain a second elliptic curve, and determine a second base point on the second elliptic curve; and fuse the second base point and the hash identifier based on the second elliptic curve, to obtain the signature public key.

In an embodiment, the signature private key transmitting module 1306 is further configured to: obtain a verification code, and determine an encryption key generation algorithm; process the verification code by using the encryption key generation algorithm, to obtain a first encryption key; encrypt the signature private key based on the first encryption key, to obtain an encrypted private key; and transmit the encrypted private key and the verification code to the terminal corresponding to the digital account creator identifier, the transmitted encrypted private key and verification code being configured for triggering the terminal to decrypt the encrypted private key based on the verification code, to obtain the signature private key.

In an embodiment, the signature private key transmitting module 1306 is further configured to: obtain a salt, and generate an initial key block for a current round based on the verification code and the salt; obtain a key block for a previous round, and concatenate the initial key block for the current round and the key block for the previous round, to obtain a key block for the current round; enter a next round when a byte length of the key block for the current round does not satisfy a preset length condition, use the next round as the current round, and return to continue to perform the operation of generating an initial key block for a current round based on the verification code and the salt until a byte length of a key block for the current round satisfies the preset length condition; and use a key block for a last round as the first encryption key.

In an embodiment, the signature private key transmitting module 1306 is further configured to: obtain encoded data, and concatenate the salt with the encoded data, to obtain a target salt; perform a hash operation on the verification code and the target salt, to obtain the 1^{st} hash key block; generate a current hash key block based on the verification code and a previous hash key block in a generation process of the current hash key block starting from a generation process of the 2^{nd} hash key block; use a generation process of a next hash key block as the generation process of the current hash key block, and return to continue to perform the operation of determining a current hash key block based on the verification code and a previous hash key block until a preset quantity of hash key blocks are generated; and use a last hash key block as the initial key block for the current round.

In an embodiment, the resource processing apparatus 1300 further includes a resource processing module, configured to: receive a resource processing request including the digital signature; verify the digital signature based on the signature public key; respond, after the verification succeeds, to the resource processing request by using a smart contract bound with the digital account, to process the resource in the digital account, to obtain a resource processing result; and store the resource processing result in a blockchain, where the resource processing result is subject to a consensus of consensus nodes in the blockchain.

In an embodiment, as shown in FIG. 14, a signature private key obtaining apparatus 1400 is provided, and includes: a request generation module 1402, a request transmitting module 1404, and a key receiving module 1406.

The request generation module 1402 is configured to: obtain a digital account creator identifier, and generate a digital account creation request based on the digital account creator identifier;

The request transmitting module 1404 is configured to transmit the digital account creation request, the transmitted digital account creation request being configured for triggering creation of a digital account, a signature public key, and a signature private key based on the digital account creator identifier, and being configured for triggering generation of a verification code and encryption of the signature private key based on the verification code, to obtain an encrypted private key.

The key receiving module 1406 is configured to: receive the encrypted private key and the verification code, and decrypt the encrypted private key based on the verification code, to obtain the signature private key, the signature private key being configured for generating, in a resource processing process based on the signature private key, a resource processing request including a digital signature, and the digital signature being configured for triggering processing of a virtual resource in the digital account based on the resource processing request after verification performed on the digital signature based on the signature public key bound with the digital account succeeds.

In an embodiment, the key receiving module 1406 is further configured to: process the verification code by using the encryption key generation algorithm, to obtain a second encryption key; and decrypt the encrypted private key based on the second encryption key, and obtain the signature private key when the decryption succeeds.

In an embodiment, the key receiving module 1406 is further configured to: display the verification code and a verification code fill-in box when the verification code transmitted by the server is received; display a filled-in verification code in response to a filling operation on the verification code fill-in box; and transmit the filled-in verification code to the server, the transmitted filled-in verification code being configured for triggering the server to perform consistency comparison between the filled-in verification code and the transmitted verification code, and determine, when the filled-in verification code is consistent with the transmitted verification code, that the signature private key is successfully delivered.

In an embodiment, the signature private key obtaining apparatus 1400 further includes an item obtaining module, configured to: display multiple items, and display, in response to a selection operation for the multiple items, a detail page of an item selected through the selection operation, the detail page displaying an item obtaining control and a quantity of resources required to obtain the item selected through the selection operation; generate, in response to a trigger operation on the item obtaining control, a resource processing packet based on the quantity of resources required to obtain the item selected through the selection operation; and sign the resource processing packet by using the signature private key, to obtain the digital signature, and generate the resource processing request based on the digital signature.

All or some of the modules in the foregoing resource processing apparatus and the signature private key obtaining apparatus may be implemented by using software, hardware, and a combination thereof. The modules may be built in or stand alone from a processor in a computer device in a form of hardware, or may be stored in a memory in a computer device in a form of software, so that a processor can invoke and execute operations corresponding to the modules.

In this disclosure, a unit and a module may be hardware such as a combination of electronic circuitries; firmware; or software such as computer instructions. The unit and the module may also be any combination of hardware, firmware, and software. In some implementation, a unit may include at least one module. Each unit or module can be implemented using one or more processors (or processors and memory). Likewise, a processor (or processors and memory) can be used to implement one or more units or modules. Moreover, each unit or module can be part of an overall unit or module that includes the functionalities of the unit or module.

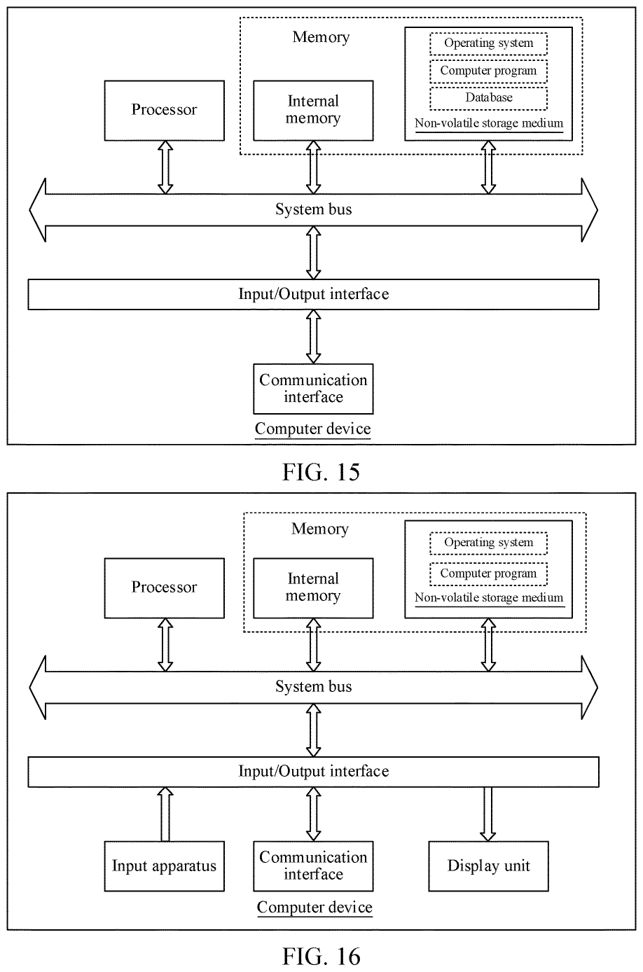

In an embodiment, a computer device is provided. The computer device may be a server, and a diagram of an internal structure thereof may be shown in FIG. 15. The computer device includes a processor, a memory, an input/output (briefly referred to as I/O) interface, and a communication interface. The processor, the memory, and the input/output interface are connected to each other through a system bus, and the communication interface is connected to the system bus through the input/output interface. The processor of the computer device is configured to provide computing and control capabilities. The memory of the computer device includes a non-volatile (or non-transitory) storage medium and an internal memory. The non-volatile storage medium has an operating system, a computer program, and a database stored therein. The internal memory provides an environment for operation of the operating system and the computer program in the non-volatile storage medium. The database of the computer device is configured for storing digital account creation data. The input/output interface of the computer device is configured to exchange information between the processor and an external device. The communication interface of the computer device is configured to connect and communicate with the external terminal via a network. The computer program is executed by the processor to implement a resource processing method.

In an embodiment, a computer device is provided. The computer device may be a terminal, and an internal structure diagram of the computer device may be shown in FIG. 16. The computer device includes a processor, a memory, an input/output interface, a communication interface, a display unit, and an input apparatus. The processor, the memory, and the input/output interface are connected to each other through a system bus, and the communication interface, the display unit, and the input apparatus are connected to the system bus through the input/output interface. The processor of the computer device is configured to provide computing and control capabilities. The memory of the computer device includes a non-volatile storage medium and an internal memory. The non-volatile storage medium has an operating system and a computer program stored therein. The internal memory provides an environment for operation of the operating system and the computer program in the non-volatile storage medium. The input/output interface of the computer device is configured to exchange information between the processor and an external device. The communication interface of the computer device is configured to communicate with an external terminal in a wired or wireless manner. The wireless manner may be implemented through Wi-Fi, a mobile cellular network, near field communication (NFC), or another technology. The computer program is executed by the processor to implement a signature private key obtaining method. The display unit of the computer device may be configured for forming a visually visible screen, and may be a display screen, a projection apparatus, or a virtual reality imaging apparatus. The display screen may be a liquid crystal display screen or an e-ink display screen. The input apparatus of the computer device may be a touch layer covering the display screen, or may be a button, a trackball, or a touchpad disposed on a housing of the computer device, or may be an external keyboard, touchpad, mouse, or the like.

A person skilled in the art may understand that, the structures shown in FIG. 15 and FIG. 16 are merely block diagrams of a partial structure related to a solution in this application, and does not constitute a limitation on the computer device to which the solution in this application is applied. Specifically, the computer device may include more or fewer parts than those shown in the figure, or have some parts combined, or have a different part deployment.

In an embodiment, a computer device is further provided, and includes: a memory and a processor. The memory has a computer program stored therein, and the computer program is executed by the processor to perform the operations of the foregoing method embodiments.

In an embodiment, a non-transitory computer-readable storage medium is provided, and has a computer program stored therein. The computer program is executed by a processor to perform the operations of the foregoing method embodiments.

In an embodiment, a computer program product or a computer program is provided, and includes computer instructions stored in a non-transitory computer-readable storage medium. A processor of a computer device reads the computer instructions from the computer-readable storage medium, and the processor executes the computer instructions, to cause the computer device to perform the operations of the foregoing method embodiments.

User information (including, but not limited to, information about user equipment, user personal information, and the like) and data (including, but not limited to, data for analysis, stored data, displayed data, and the like) in this application are all information and data authorized by a user or fully authorized by all parties, and collection, use, and processing of relevant data need to comply with relevant laws, regulations, and standards of relevant countries and regions.

A person of ordinary skill in the art may understand that all or some of procedures of the method in the foregoing embodiments may be implemented by a computer program instructing relevant hardware. The program may be stored in a non-volatile computer-readable storage medium. When the program is executed, the procedures of the foregoing method embodiments may be included. Any reference to a memory, a database, or other media used in the embodiments provided in this application may include at least one of a non-volatile memory and a volatile memory. The non-volatile memory may include a read-only memory (ROM), a magnetic tape, a floppy disk, a flash memory, an optical memory, a high-density embedded non-volatile memory, a resistive random-access memory (ReRAM), a magnetoresistive random-access memory (MRAM), a ferroelectric random-access memory (FRAM), a phase change memory (PCM), a graphene memory, and the like. The volatile memory may include a random-access memory (RAM) and an external cache. For the purpose of illustration but not limitation, the RAM is available in many forms, for example, static random access memory (SRAM) or dynamic random access memory (DRAM), and the like. The databases in the embodiments provided in this application may include at least one of a relational database and a non-relational database. The non-relational database may include, but is not limited to, a blockchain-based distributed database and the like. The processors in the embodiments provided in this application may be general-purpose processors, central processing units, graphics processors, digital signal processors, programmable logic devices, data processing logic devices based on quantum computing, and are not limited thereto.

Technical features of the foregoing embodiments may be combined in different manners to form other embodiments. To make description concise, not all possible combinations of the technical features in the foregoing embodiments are described. However, the combinations of these technical features shall be considered as falling within the scope recorded in this specification provided that no conflict exists.

The foregoing embodiments only describe several implementations of this application, which are described specifically and in detail, but cannot be construed as a limitation on the patent scope of the present invention. For a person of ordinary skill in the art, several transformations and improvements can be made without departing from the idea of this application. These transformations and improvements belong to the protection scope of this application. Therefore, the protection scope of the patent of this application shall be subject to the appended claims.

What is claimed is:

1. A method for resource processing method, performed by a server, comprising:
receiving a digital account creation request, and extracting a digital account creator identifier from the digital account creation request;
creating, based on the digital account creator identifier, a digital account configured for storing a virtual resource;
obtaining a preset master public key, and generating a signature public key of the digital account based on the master public key and the digital account creator identifier;
obtaining a master private key paired with the master public key, and generating, based on the master private key and the signature public key, a signature private key paired with the signature public key;
transmitting the signature private key to a terminal corresponding to the digital account creator identifier, wherein the transmitted signature private key triggers the terminal to generate a digital signature based on the signature private key;
receiving a resource processing request fed back by the terminal, the resource processing request comprising the digital signature; and
processing the virtual resource in the digital account based on the resource processing request after verification performed on the digital signature based on the signature public key of the digital account succeeds.

2. The method according to claim 1, further comprising:
generating a random number, and using the random number as the master private key;
obtaining a first elliptic curve, and determining a first base point on the first elliptic curve; and
performing a point multiplication operation on the first base point and the master private key, to obtain the master public key paired with the master private key.

3. The method according to claim 1, wherein generating the signature public key of the digital account based on the master public key and the digital account creator identifier comprises:
concatenating multiple digital account creator identifiers and the master public key when the multiple digital account creator identifiers are extracted from the digital account creation request, to obtain a concatenated identifier;
performing a hash operation on the concatenated identifier, to obtain a hash identifier; and
generating the signature public key based on the hash identifier.

4. The method according to claim 3, wherein generating the signature public key based on the hash identifier comprises:
obtaining a second elliptic curve, and determining a second base point on the second elliptic curve; and
fusing the second base point and the hash identifier based on the second elliptic curve, to obtain the signature public key.

5. The method according to claim 1, wherein generating, based on the master private key and the signature public key, the signature private key paired with the signature public key comprises:
multiplying the master private key by the signature public key, to obtain the signature private key paired with the signature public key.

6. The method according to claim 1, wherein transmitting the signature private key comprises:
obtaining a verification code, and determining an encryption key generation algorithm;
processing the verification code by using the encryption key generation algorithm, to obtain a first encryption key;
encrypting the signature private key based on the first encryption key, to obtain an encrypted private key; and
transmitting the encrypted private key and the verification code to the terminal corresponding to the digital account creator identifier, wherein the transmitted encrypted private key and verification code trigger the terminal to decrypt the encrypted private key based on the verification code, to obtain the signature private key.

7. The method according to claim 6, wherein processing the verification code by using the encryption key generation algorithm, to obtain the first encryption key comprises:
obtaining a salt, and generating an initial key block for a current round based on the verification code and the salt;
obtaining a key block for a previous round, and concatenating the initial key block for the current round and the key block for the previous round, to obtain a key block for the current round;
when a byte length of the key block for the current round does not satisfy a preset length condition, entering a next round, treating the next round as the current round, and repeating the operation of generating the initial key block for a current round based on the verification code and the salt, until a byte length of the key block for the current round satisfies the preset length condition; and
using the key block for a last round as the first encryption key.

8. The method according to claim 7, wherein generating the initial key block for the current round based on the verification code and the salt comprises:
obtaining encoded data, and concatenating the salt and the encoded data to obtain a target salt;
performing a hash operation on the verification code and the target salt, to obtain a 1^{st} hash key block;
starting from a generation process of a 2^{nd} hash key block, generating a current hash key block based on the verification code and a previous hash key block;
entering a generation process of a next hash key block, treating the generation process of the next hash key block as the generation process of the current hash key block, and repeating the operation of generating a current hash key block based on the verification code and the previous hash key block, until a preset quantity of hash key blocks are generated; and
using a last hash key block as the initial key block for the current round.

9. The method according to claim 1, further comprising:
receiving the resource processing request comprising the digital signature;
verifying the digital signature in the resource processing request based on the signature public key;
responding, after the verification succeeds, to the resource processing request based on a smart contract bound with the digital account, to process the virtual resource in the digital account, and obtain a resource processing result; and
storing the resource processing result in a blockchain.

10. A method for obtaining signature private key, performed by a terminal, comprising:
obtaining a digital account creator identifier, and generating a digital account creation request based on the digital account creator identifier;
transmitting the digital account creation request, wherein the transmitted digital account creation request triggers creation of a digital account, a signature public key, and a signature private key based on the digital account creator identifier, triggers generation of a verification code and encryption of the signature private key based on the verification code, to obtain an encrypted private key;
receiving the encrypted private key and the verification code; and
decrypting the encrypted private key based on the verification code, to obtain the signature private key, wherein the signature private key is used for generating, in a resource processing process based on the signature private key, a resource processing request comprising a digital signature, and wherein the digital signature triggers processing of a virtual resource in the digital account based on the resource processing request after verification performed on the digital signature based on a signature public key bound with the digital account succeeds.

11. The method according to claim 10, wherein decrypting the encrypted private key based on the verification code, to obtain the signature private key comprises:
processing the verification code by using an encryption key generation algorithm, to obtain a second encryption key; and
decrypting the encrypted private key based on the second encryption key, and obtaining the signature private key when the decryption succeeds.

12. The method according to claim 11, further comprising:
when a verification code transmitted by a server is received, displaying the verification code and a verification code fill-in box;
displaying a filled-in verification code in response to a filling operation on the verification code fill-in box; and
transmitting the filled-in verification code to the server, wherein the transmitted filled-in verification code triggers the server to perform a consistency comparison between the filled-in verification code and the verification code transmitted by the server, and triggers to determine, when the filled-in verification code is consistent with the verification code transmitted by the server, that the signature private key is successfully delivered.

13. The method according to claim 10, wherein generating the resource processing request comprises:
displaying multiple items, and displaying, in response to a selection operation for the multiple items, a detail page of an item selected through the selection operation, the detail page displaying an item obtaining control and a quantity of resources required to obtain the selected;
generating, in response to a trigger operation on the item obtaining control, a resource processing packet based on the quantity of resources required to obtain the selected item; and
signing the resource processing packet by using the signature private key, to obtain the digital signature, and generating the resource processing request based on the digital signature.

14. A device comprising a memory for storing computer instructions and a processor in communication with the memory, wherein, when the processor executes the computer instructions, the processor is configured to cause the device to:
receive a digital account creation request, and extract a digital account creator identifier from the digital account creation request;
create, based on the digital account creator identifier, a digital account configured for storing a virtual resource;
obtain a preset master public key, and generating a signature public key of the digital account based on the master public key and the digital account creator identifier;
obtain a master private key paired with the master public key, and generating, based on the master private key and the signature public key, a signature private key paired with the signature public key;
transmit the signature private key to a terminal corresponding to the digital account creator identifier, wherein the transmitted signature private key triggers the terminal to generate a digital signature based on the signature private key;
receive a resource processing request fed back by the terminal, the resource processing request comprising the digital signature; and
process the virtual resource in the digital account based on the resource processing request after verification performed on the digital signature based on the signature public key of the digital account succeeds.

15. The device according to claim 14, wherein, when the processor executes the computer instructions, the processor is configured to further cause the device to:
generate a random number, and using the random number as the master private key;
obtain a first elliptic curve, and determining a first base point on the first elliptic curve; and
perform a point multiplication operation on the first base point and the master private key, to obtain the master public key paired with the master private key.

16. The device according to claim 14, wherein, when the processor is configured to cause the device to generate the signature public key of the digital account based on the master public key and the digital account creator identifier, the processor is configured to cause the device to:
concatenate multiple digital account creator identifiers and the master public key when the multiple digital account creator identifiers are extracted from the digital account creation request, to obtain a concatenated identifier;
perform a hash operation on the concatenated identifier, to obtain a hash identifier; and
generate the signature public key based on the hash identifier.

17. The device according to claim 16, wherein, when the processor is configured to cause the device to generate the signature public key based on the hash identifier, the processor is configured to cause the device to:
obtain a second elliptic curve, and determining a second base point on the second elliptic curve; and
fuse the second base point and the hash identifier based on the second elliptic curve, to obtain the signature public key.

18. The device according to claim 14, wherein, when the processor is configured to cause the device to generate, based on the master private key and the signature public key, the signature private key paired with the signature public key, the processor is configured to cause the device to:
multiply the master private key by the signature public key, to obtain the signature private key paired with the signature public key.

19. The device according to claim 14, wherein, when the processor is configured to cause the device to transmit the signature private key, the processor is configured to cause the device to:
obtain a verification code, and determining an encryption key generation algorithm;
process the verification code by using the encryption key generation algorithm, to obtain a first encryption key;
encrypt the signature private key based on the first encryption key, to obtain an encrypted private key; and
transmit the encrypted private key and the verification code to the terminal corresponding to the digital account creator identifier, wherein the transmitted encrypted private key and verification code trigger the terminal to decrypt the encrypted private key based on the verification code, to obtain the signature private key.

20. The device according to claim 19, wherein, when the processor is configured to cause the device to process the verification code by using the encryption key generation algorithm, to obtain the first encryption key, the processor is configured to cause the device to:
obtain a salt, and generating an initial key block for a current round based on the verification code and the salt;
obtain a key block for a previous round, and concatenating the initial key block for the current round and the key block for the previous round, to obtain a key block for the current round;
when a byte length of the key block for the current round does not satisfy a preset length condition, entering a next round, treat the next round as the current round, and repeat the operation of generating the initial key block for a current round based on the verification code and the salt, until a byte length of the key block for the current round satisfies the preset length condition; and
use the key block for a last round as the first encryption key.
